(19) United States
(12) Patent Application Publication
(10) Pub. No.: US 2007/0005526 A1
(43) Pub. Date: Jan. 4, 2007

(54) Scenario representation manipulation methods, scenario analysis devices, articles of manufacture, and data signals

(76) Inventors: Paul Whitney, Richland, WA (US); McLean Sloughter, Seattle, WA (US); George Chin JR., Richland, WA (US); Olga Anna Kuchar, Richland, WA (US); Katherine E. Wolf, Richland, WA (US); Mary Powers, Richland, WA (US)

Correspondence Address: WELLS ST. JOHN P.S., 601 W. FIRST AVENUE, SUITE 1300, SPOKANE, WA, 99201, US

(21) Appl. No.: 11/157,605

(22) Filed: Jun. 21, 2005

(51) Int. Cl. G06N 3/02

(52) U.S. Cl. 706/15

(57) ABSTRACT

Scenario representation manipulation methods, scenario analysis devices, articles of manufacture, and data signals are described according to some aspects. In one aspect, a scenario representation manipulation method includes accessing a graphical representation comprising a plurality of nodes and a plurality of associations of the nodes, wherein the nodes and the associations of the nodes are indicative of a scenario, providing a plurality of defined structural arrangements, wherein the defined structural arrangements comprise a plurality of nodes and associations of the nodes, analyzing the nodes and associations of the nodes of the graphical representation using the defined structural arrangements, and generating another representation of the graphical representation responsive to the analyzing.

### GOVERNMENT RIGHTS STATEMENT

This invention was made with Government support under Contract DE-AC0676RLO1830 awarded by the U.S. Department of Energy. The Government has certain rights in the invention.

### TECHNICAL FIELD

This invention relates to scenario representation manipulation methods, scenario analysis devices, articles of manufacture, and data signals.

### BACKGROUND

There is increased interest and importance for providing improved techniques and systems for processing data for use by analysts. For example, analysts may over time observe numerous fact patterns and attempt to associate different fact patterns or portions of different fact patterns with one another in an attempt to gain further insight into unknown facts or circumstances related to a factual situation being analyzed.

Analysis of different factual situations may be used by law enforcement and related agencies when trying to understand more about situations wherein facts are missing, for example, when trying to solve crimes or predict future acts. More recently, there has been an increased focus upon analysis of past situations in an attempt to gain insight into acts which may occur in the future. For example, analysts may analyze a plurality of past terrorist attacks in an attempt to gain information of how, when and/or where (or any other related information) an attack may occur in the future. At least some aspects of the disclosure include improved methods, apparatus, articles of manufacture and data signals for use in analyzing factual situations.

### BRIEF DESCRIPTION OF THE DRAWINGS

Preferred embodiments of the invention are described below with reference to the following accompanying drawings.

FIG. 1 is an illustrative representation of a computing device according to one embodiment.

FIG. 2 is a functional block diagram of components of an exemplary computing device according to one embodiment.

FIG. 3 is an illustrative representation of a scenario according to one embodiment.

FIG. 4 illustrates a plurality of defined patterns which may be used for analysis of a scenario according to one embodiment.

FIG. 5 is a flow chart of an exemplary method of analyzing a scenario according to one embodiment.

### DETAILED DESCRIPTION

Attention is directed to the following commonly assigned application entitled “Scenario Analysis Methods, Scenario Analysis Devices, Articles Of Manufacture, And Data Signals”, listing Olga Anna Kuchar, George Chin, Jr., Paul Whitney, Mary Powers, and Katherine E. Johnson as inventors, having Docket No. 14330-E, filed the same day as the present application, and which is incorporated herein by reference.

According to one aspect of the disclosure, a scenario representation manipulation method comprises accessing a graphical representation comprising a plurality of nodes and a plurality of associations of the nodes, wherein the nodes and the associations of the nodes are indicative of a scenario, providing a plurality of defined structural arrangements, wherein the defined structural arrangements comprise a plurality of nodes and associations of the nodes, analyzing the nodes and associations of the nodes of the graphical representation using the defined structural arrangements, and generating another representation of the graphical representation responsive to the analyzing.

According to another aspect of the disclosure, a scenario representation manipulation method comprises providing a first representation of a scenario; wherein the first representation comprises a first quantity of digital data, analyzing the first representation to compress the first representation of the scenario, and providing a second representation of the scenario responsive to the analyzing of the first representation, wherein the second representation comprises a second quantity of digital data less than the first quantity of the digital data.

According to yet another aspect of the disclosure, a scenario analysis device comprises processing circuitry configured to access data regarding a graphical representation of a scenario, to access data regarding a plurality of defined patterns, to determine numbers of individual ones of the defined patterns present in the graphical representation, and to provide another representation of the scenario using the numbers.

According to still another aspect of the disclosure, a scenario analysis device comprises means for accessing a graphical representation of a scenario, wherein the graphical representation comprises a plurality of nodes and a plurality of associations of the nodes indicative of the scenario, means for analyzing the graphical representation, and means for generating a signature of the graphical representation responsive to analysis of the graphical representation, wherein the signature comprises a mathematical expression indicative of data of the scenario represented by the graphical representation.

According to an additional aspect of the disclosure, an article of manufacture comprises processor usable media comprising programming configured to cause processing circuitry to perform processing comprising accessing a graphical representation comprising a plurality of nodes and a plurality of associations of the nodes, wherein the nodes and the associations of the nodes are indicative of a scenario, accessing a plurality of defined patterns comprising nodes and associations of the nodes of the defined patterns, analyzing the nodes and associations of the nodes of the graphical representation using the defined patterns, and providing another representation of the scenario different than the graphical representation responsive to the analyzing.

According to still yet another aspect of the disclosure, a data signal embodied in a transmission medium comprises programming configured to cause processing circuitry to access data regarding a graphical representation of a scenario, programming configured to cause processing circuitry to access data regarding a plurality of defined patterns, programming configured to cause processing circuitry to determine numbers of the defined patterns present in the graphical representation, and programming configured to cause processing circuitry to provide another representation of the scenario using the numbers.

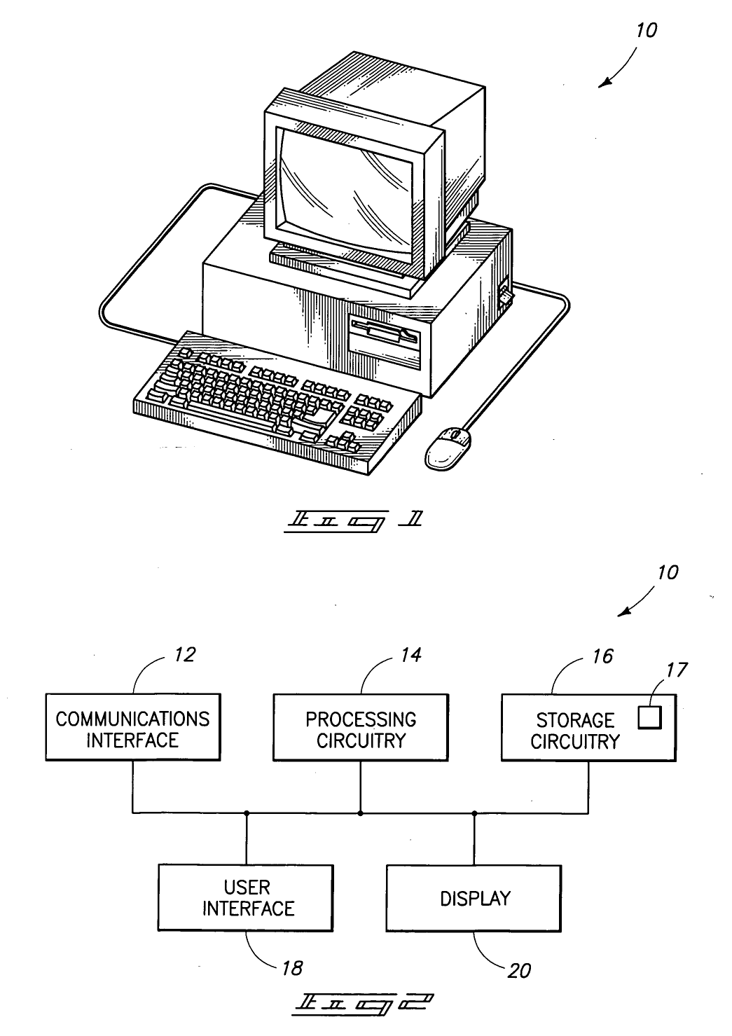

Referring to FIG. 1, an exemplary computing device 10 is illustrated. Computing device 10 may be implemented as a personal computer, workstation, or any suitable processing device configured to process digital data, user input, and/or other information.

Computing device 10 may be referred to as a scenario analysis device in one embodiment. A scenario may comprise information regarding objects (e.g., people, events, entities, etc.) and relationships of the objects with one another, with the environment and/or other associations. Scenarios may incorporate temporal relationships among information elements as well as spatial, logical and categorical relationships. Scenarios may be analyzed for various reasons including for purposes to gain knowledge which was previously unknown in some embodiments. For example, analysts in law enforcement or homeland security may analyze scenarios in an effort to identify plans may which be carried out at some point in time in the future (e.g., terrorism). Additional details regarding exemplary operations of computing device 10 to analyze and manipulate scenarios are described below.

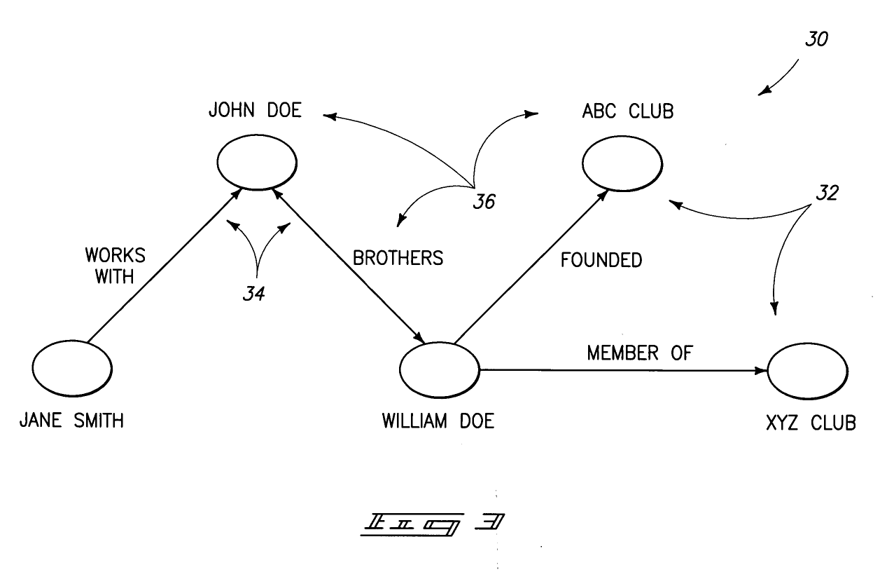

Referring to FIG. 2, components of a computing device 10 configured according to one embodiment are shown. The exemplary device 10 includes a communications interface 12, processing circuitry 14, storage circuitry 16, user interface 18 and a display 20. Other arrangements are possible including more, less and/or alternative components.

Communications interface 12 is arranged to implement communications of computing device 10 with respect to external devices (not shown). For example, communications interface 12 may be arranged to communicate information bi-directionally with respect to computing device 10. Communications interface 12 may be implemented as a network interface card (NIC), serial or parallel connection, USB port, Firewire interface, flash memory interface, floppy disk drive, or any other suitable arrangement for communicating data with respect to computing device 10.

In one embodiment, processing circuitry 14 is arranged to process data, control data access and storage, issue commands, and control other desired operations. Processing circuitry may comprise circuitry configured to implement desired programming provided by appropriate media in at least one embodiment. For example, the processing circuitry may be implemented as one or more of a processor and/or other structure configured to execute executable instructions including, for example, software and/or firmware instructions, and/or hardware circuitry. Exemplary embodiments of processing circuitry include hardware logic, PGA, FPGA, ASIC, state machines, and/or other structures alone or in combination with one or more processor. These examples of processing circuitry 14 are for illustration and other configurations are possible.

Storage circuitry 16 is configured to store electronic data and/or programming such as executable code or instructions (e.g., software and/or firmware), data, databases, or other digital information and may include processor-usable media. Processor-usable media includes any computer program product or article of manufacture 17 which can contain, store, or maintain programming, data and/or digital information for use by or in connection with an instruction execution system including processing circuitry in the exemplary embodiment. For example, exemplary processor-usable media may include any one of physical media such as electronic, magnetic, optical, electromagnetic, infrared or semiconductor media. Some more specific examples of processor-usable media include, but are not limited to, a portable magnetic computer diskette, such as a floppy diskette, zip disk, hard drive, random access memory, read only memory, flash memory, cache memory, and/or other configurations capable of storing programming, data, or other digital information.

As mentioned above, at least some embodiments or aspects described herein may be implemented using programming stored within appropriate storage circuitry described above and/or communicated via a network or using other transmission medium and configured to control appropriate processing circuitry. For example, programming may be provided via appropriate media including for example articles of manufacture, embodied within a data signal (e.g., modulated carrier wave, data packets, digital representations, etc.) communicated via an appropriate transmission medium, such as a communication network (e.g., the Internet and/or a private network), wired connection and/or electromagnetic energy for example via a communications interface, or provided using other appropriate communication structure or medium. Exemplary programming including processor-usable code may be communicated as a data signal embodied in a carrier wave in but one example.

User interface 18 is configured to interact with a user including receiving inputs from the user (e.g., tactile input, voice instruction, etc.) for example via a keyboard, mouse, microphone, etc. Any other suitable apparatus for interacting with a user may also be utilized.

Display 20 is configured to depict visual information to a user. In exemplary embodiments, display 20 is arranged as a cathode ray tube monitor, LCD monitor, etc.

In an exemplary arrangement configured as a scenario analysis device, the computing device 10 is configured to access representations of scenarios. In one embodiment, scenarios may be represented graphically to illustrate objects and associations or relationships of the objects. As discussed below, computing device 10 may analyze and manipulate representations of scenarios.

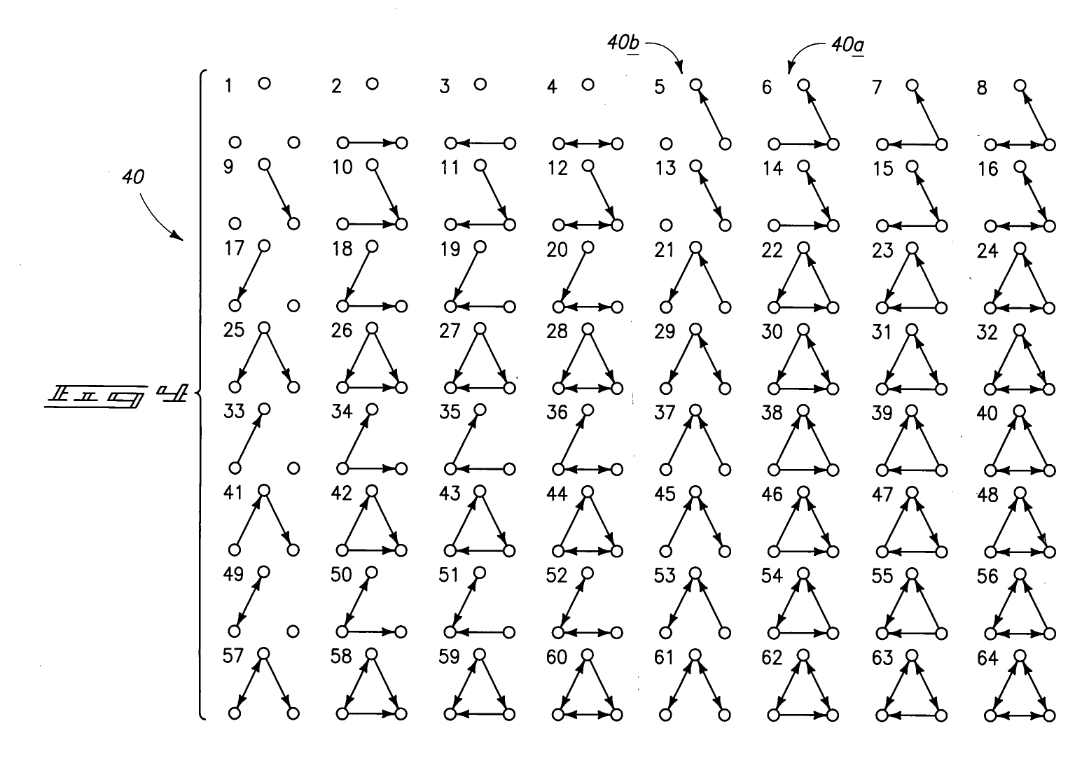

Referring to FIG. 3, an exemplary graphical representation 30 of a scenario is depicted. Exemplary existing programming applications which may be used to generate graphical representations 30 of scenarios include Analyst's Notebook, Watson, VisuaLinks, and Starlight. These applications enable convenient representation of objects and associations of objects of a scenario for observation, discussion, and/or analysis by an analyst.

The graphical representation 30 of FIG. 3 illustrates a plurality of objects represented as nodes 32 and a plurality of links or edges 34 which illustrate associations of the objects with one another (if appropriate) providing structural information regarding an arrangement of nodes 32. Individual nodes 32 may have associations with one or more other nodes 32 as represented by edges 34 in the depicted example. Further, associations of nodes 32 may be directional (e.g., one or both directions) as represented by edges 34 in the form of arrows. Exemplary objects include people, places, communications, entities, organizations or any other object which may be associated with other objects of the scenario being represented. Nodes 32 of a graphical representation 30 of a scenario may be referred to as scenario nodes. Exemplary illustrated associations may include relationships (e.g., familial, acquaintances, employment, etc.), hierarchies, financial transactions, meetings or other associations otherwise capable of being represented. In one embodiment, labels 36 may be associated with nodes 30 and/or links 32 to identify the respective objects and associations. In addition, nodes 32 or edges 34 may include other information regarding an object or association of objects in addition to what is represented by labels 36. For example, if a label 36 of node 32 is a name of an individual, the node 32 may also include other information regarding the individual, such as citizenship, residence, etc. although not shown in the label 36. The illustrated graphical representation 30 is merely for discussion purposes and other variants are possible.

Once created, graphical representations and/or files of graphical representations 30 may be organized and filed for later use. For example, the graphical representations 30 and/or files may be filed in a case library (e.g., using storage circuitry 16, an external database, etc.). During review of other scenarios at subsequent moments in time, an analyst may recall similarities to previously analyzed and filed scenarios, and accordingly, attempt to locate the desired representations of the scenarios. For example, the previously stored or analyzed scenarios may have objects and/or associations of objects which are similar to a scenario being analyzed and may provide insight into the analysis of the current scenario.

Once the desired scenarios are identified, the analysts may analyze the identified scenarios with respect to the current scenario in an attempt to identify similarities or gain insight or leads into the current scenario being studied. However, challenges are presented by attempts to locate previously filed graphical representations 30 of scenarios inasmuch as significant amounts of time are used to search using graphical search techniques which may attempt to identify relevant graphical representations stored in a database by matching them to a current graphical representation of the scenario being analyzed using graph processing programs which analyze the graphics. More specifically, it is not uncommon for graphical representations 30 to be significantly larger than the example of FIG. 3 including numerous additional nodes 30 and associations of nodes 32 which further complicates and/or slows searching of the scenarios. At least some aspects of the disclosure provide systems and methods which facilitate searching of graphical representations of scenarios.

More specifically, in exemplary embodiments, methods and apparatus (e.g., computing device 10) are arranged to use initial (e.g., graphical) representations of scenarios to generate additional representations of the scenarios to facilitate processing (e.g., searching and identification) of the scenarios at later moments in time. For example, the newly generated representations of the scenarios may be used to reduce the searching and processing time performed to identify previously generated and stored scenarios which may have similar aspects to a scenario being studied. Following identification of scenarios of interest using the generated representations, the respective graphical representations of the scenarios may be accessed and utilized for further analysis with respect to the subject scenario being analyzed or for other purposes.

According to one embodiment, aspects of the disclosure provide generation of additional representations of the scenarios using the graphical representations 30 of the scenarios. In one implementation, the additional representations of the scenarios are analytical signatures comprising mathematical representations (e.g., vectors) of graphical structural arrangements of scenarios. As described below according to one exemplary embodiment, the computing device 10 may develop the analytical signatures comprising signature vectors which capture salient features of the respective scenarios. In a more specific example, exemplary signature vectors are mathematical structures based on n-ary relations with allowances for missing information and highly labeled directed graphs in one arrangement. In one embodiment, the analytical signatures include numeric representations which represent structure information of the graphical representations 30 of the scenarios and may be constructed at the graph and/or node level. The signature vectors may include information regarding structure of relationships of the objects and/or content of the relationships or associations of the objects with one another.

In one embodiment, a plurality of features or patterns of a graphical representation 30 may be used to generate a different representation of the scenario represented by the graphical representation 30. According to one implementation, computing device 10 may be configured to determine the presence of different features or patterns within the graphical representation 30 to generate a different representation of a scenario comprising a signature vector.

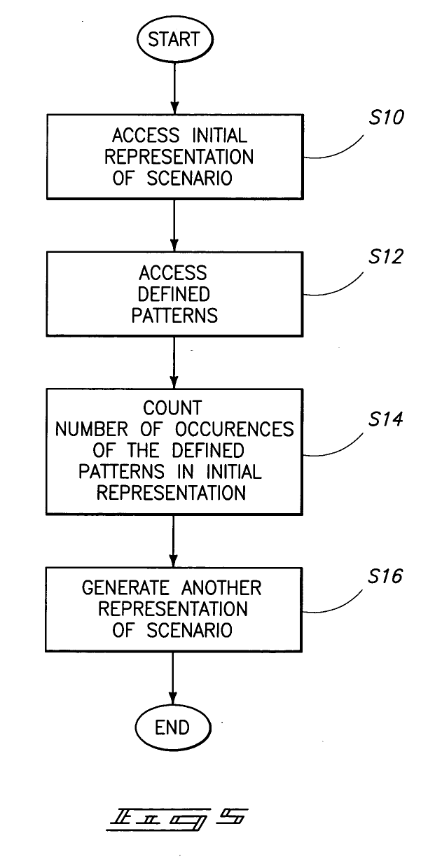

Referring to FIG. 4, a plurality of exemplary defined patterns 40 which -may be used to provide additional representations of scenarios represented graphically are shown. The defined patterns 40 are unique structural arrangements individually including a plurality of nodes and association(s) of the nodes. The nodes of defined patterns 40 may be referred to as pattern nodes. The exemplary defined patterns 40 in one embodiment include triads individually comprising three nodes and association(s) of the nodes. In such an embodiment, a numeric signature vector of length 2⁶=64 could be constructed based on the occurrence of 64 triad patterns. Other types of patterns may be used in other embodiments.

In one embodiment, the graphical representation of a subject scenario being studied may be analyzed with respect to the defined patterns 40. For example, in one embodiment, for each of the defined patterns 40, a number (also referred to as a coordinate) is provided corresponding to the number of times the respective defined pattern 40 occurs in the graphical representation 30. According to the described embodiment, sixty-four exemplary triads are shown, and sixty-four different numbers or coordinates may be generated responsive to the analysis of a given graphical representation 30 and individually corresponding to the number of times the respective defined pattern 40 occurs in the graphical representation. The numbers of occurrences are global characteristics of the graphical representation 30. In one exemplary embodiment, the numbers of occurrences may be used to formulate the analytical signature comprising a mathematical representation of a scenario. The mathematical representation may comprise a numeric signature vector which is indicative of the respective graphical representation 30 and captures salient structural features of the graphical representation 30 being analyzed.

In one implementation, the ascertained numbers of the respective patterns 40 may be modified to assure that the signature representation of the scenario generated from the graphical representation 30 is sub-graph preserving. Sub-graph preserving operations result in measures that do not change significantly if a piece of a graph is added or deleted. For example, in one implementation, the presence of one pattern 40 increments the number or count for the respective pattern 40 as well as the number(s) of the pattern(s) 40 which include the respective pattern 40 to implement subgraph preserving operations. In the example of FIG. 4, the presence of pattern 40b in a graphical representation 30 will result in the numbers of both patterns 40a, 40 b being incremented (i.e., pattern 40a includes pattern 40b or in other words pattern 40b is a sub-graph of pattern 40a) by processing circuitry 14.

Other potentially useful measures on graphs and nodes of graphs in addition to defined patterns 40 may additionally be used to generate additional representations of a scenario. Exemplary additional measures include: degrees of nodes (i.e., the number of edges attached to a node and/or the type of edges entering or leaving the node wherein global measures may be constructed based on a distribution of the degree over the nodes in the graph), gamma index (i.e., the number of observed edges compared with a total number of possible edges—a measure of connectivity), clustering coefficient of a node (e.g., the proportion of nodes connected with a given node that are connected with each other), the order or size of a graph (e.g., the number of nodes and/or edges), connectedness (e.g., whether two particular nodes or node types are connected), number of connected sub-graphs or patterns, and/or the occurrence of particular sub-patterns as described in “Social Network Analysis: Methods and Applications”, Wasserman et al., Cambridge University Press, 1994 and “Algebraic Models for Social Networks”, Philippa Pattison, Cambridge, 1993, the teachings of both articles are incorporated herein by reference and which describe that particular patterns of triads may be used as characteristics of social networks. Descriptions of additional features are described in “Social Network Analysis: Methods and Applications”, Wasserman et al., Cambridge University Press, 1994, incorporated by reference above, and “Graph Theory Indexes and Measures”, Jean-Paul Rodrigue, http://people. hofstra.edu/geotrans/eng/ch2en/meth2en/ch2m2en.html, February 2004, the teachings which are incorporated herein by reference. The features utilized for generation of an additional representation of a graphical representation may be changed or varied dependent upon the objectives of the analysis.

Provision of a representation of a scenario in another format in addition to a graphical representation (e.g., vector) may facilitate further analysis of the scenario or other (e.g., related) scenarios. For example, vectors may be searched in a more straightforward manner compared with graphical searching techniques and may permit a relatively large number of scenarios to be searched in a relatively short period of time. Further, the amount of digital data of a vector representation of a scenario is typically significantly less than an amount of digital data for a graphical representation of the scenario while the vector representation retains information regarding the scenario (e.g., structural information regarding the nodes and associations of the nodes and which may further include label information of the nodes).

Referring to FIG. 5, an exemplary methodology for generating a new representation of a scenario from an initial representation of the scenario is shown. Processing circuitry 14 of computing device 10 may be arranged to implement the method in one embodiment to manipulate representations of a scenario. Other methods are possible including more, less and/or alternative steps.

At a step S10, the processing circuitry may access a file of an initial (e.g., graphical) representation of a scenario to be analyzed. In exemplary embodiments, files of initial representations of scenarios may be accessed from a communications interface or storage circuitry of the computing device. The initial representation may include a graphical representation of the scenario including both structural aspects (e.g., nodes, edges which indicate associations or links of the nodes) and labels of the nodes and/or edges.

At a step S12, the processing circuitry may access a list of defined patterns or structural arrangements of nodes and edges which may be used to analyze the graphical representation. In one embodiment, the defined patterns include different triad patterns.

At a step S14, the processing circuitry analyzes the graphical representation of the scenario by counting the number of occurrences of each of the defined patterns in the graphical representation. For example, the processing circuitry may access a given pattern, search for the presence of the respective pattern within the graphical representation by comparing the defined pattern with respect to arrangements of nodes and edges occurring in the graphical representation, and store the number of occurrences of the pattern within the graphical representation. This may be repeated for the other defined patterns. In one embodiment, the processing circuitry may increment a counted number of a pattern when a sub-graph of the respective pattern is counted to provide self-preserving aspects as mentioned above. In one more specific exemplary embodiment, for each group of three nodes within a graphical representation, the structure (i.e., defined triad pattern) is identified and appropriate contents of the signature vector (e.g., coordinate) that reflect the 3-node group or tried may be incremented. Every different combination of 3-node groupings of the graphical representation 30 is considered for completeness of the analytical signature in one embodiment.

At a step S16, the processing circuitry generates the new representation of the scenario including a vector using the numbers determined in step S14. The new representation may be stored using storage circuitry and/or outputted using the communications interface in exemplary embodiments for subsequent use and analysis.

As described herein, at least some aspects of the disclosure provide methods and apparatus for representing a scenario or manipulating a representation of a scenario. In one implementation, a graphical representation of a scenario is converted to another representation, such as a vector, which includes numbers of occurrences of defined patterns present within the graphical representation being analyzed. The vector may be used in subsequent operations, for example, for comparison to other vectors to identify related or similar scenarios, or other analysis operations, for example using numeric data analysis routines. Aspects of the disclosure may be useful for summarizing a collection of scenarios, retrieval of similar scenarios for suggesting additional lines of investigation, or for finding “relation paths” between key actors of a given scenario. Other uses of the generated representations of scenarios are possible.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

What is claimed is:

1. A scenario representation manipulation method comprising:
accessing a graphical representation comprising a plurality of nodes and a plurality of associations of the nodes, wherein the nodes and the associations of the nodes are indicative of a scenario;
providing a plurality of defined structural arrangements, wherein the defined structural arrangements comprise a plurality of nodes and associations of the nodes;
analyzing the nodes and associations of the nodes of the graphical representation using the defined structural arrangements; and
generating another representation of the graphical representation responsive to the analyzing.

2. The method of claim 1 wherein the graphical representation comprises structural information regarding a structural arrangement of the nodes of the graphical representation and the another representation comprises mathematical information regarding the structural information.

3. The method of claim 1 wherein the scenario comprises a plurality of associated objects.

4. The method of claim 1 wherein the generating comprises generating the another representation comprising a vector.

5. The method of claim 1 wherein the analyzing comprises comparing individual ones of the defined structural arrangements with respect to the graphical representation.

6. The method of claim 1 wherein the analyzing comprises determining numbers of occurrences of respective ones of the defined structural arrangements in the graphical representation.

7. The method of claim 6 wherein the generating comprises generating the another representation comprising a vector using the numbers of the occurrences of the defined structural arrangements.

8. The method of claim 6 wherein the determining the numbers of occurrences comprises sub-graph preserving.

9. The method of claim 1 wherein the providing comprises providing the defined structural arrangements comprising triads individually comprising three nodes.

10. The method of claim 1 wherein the another representation comprises less digital data than the graphical representation.

11. The method of claim 1 wherein the nodes comprise information regarding people and the associations comprise information regarding associations of the people with one another.

12. A scenario representation manipulation method comprising:
providing a first representation of a scenario, wherein the first representation comprises a first quantity of digital data;
analyzing the first representation to compress the first representation of the scenario; and
providing a second representation of the scenario responsive to the analyzing of the first representation, wherein the second representation comprises a second quantity of digital data less than the first quantity of the digital data.

13. The method of claim 12 wherein the first representation comprises structural information regarding a structural arrangement of nodes of the first representation and the second representation comprises mathematical information regarding the structural information.

14. The method of claim 12 wherein the first representation comprises information regarding a plurality of nodes and associations of the nodes and wherein the second representation comprises information regarding the nodes and the association of the nodes.

15. The method of claim 14 wherein the nodes comprise information regarding people and the associations comprise information regarding associations of the people with one another.

16. The method of claim 12 wherein the first representation comprises a graphical representation.

17. The method of claim 16 wherein the second representation comprises a vector.

18. A scenario analysis device comprising:
processing circuitry configured to access data regarding a graphical representation of a scenario, to access data regarding a plurality of defined patterns, to determine numbers of individual ones of the defined patterns present in the graphical representation, and to provide another representation of the scenario using the numbers.

19. The device of claim 18 wherein the graphical representation comprises structural information regarding a structural arrangement of nodes of the graphical representation and the another representation comprises mathematical information regarding the structural information.

20. The device of claim 18 wherein the graphical representation comprises information regarding a plurality of nodes and associations of the nodes, and wherein the another representation of the scenario comprises information regarding the nodes and the association of the nodes.

21. The device of claim 20 wherein the defined patterns comprise different associations of nodes.

22. The device of claim 20 wherein the nodes comprise information regarding people and the associations comprise information regarding the associations of the people with one another.

23. The device of claim 18 wherein the processing circuitry is configured to provide the another representation comprising a vector using the numbers.

24. The device of claim 18 wherein the another representation may be digitally represented using less digital data than the graphical representation.

25. The device of claim 18 wherein the processing circuitry is configured to search for the presence of individual ones of the defined patterns in the graphical representation to determine the numbers.

26. The device of claim 18 wherein the processing circuitry is configured to compare individual ones of the defined patterns with respect to the graphical representation to determine the numbers.

27. The device of claim 18 wherein the graphical representation of the scenario comprises information regarding people and associations of the people with one another.

28. A scenario analysis device comprising:
means for accessing a graphical representation of a scenario, wherein the graphical representation comprises a plurality of nodes and a plurality of associations of the nodes indicative of the scenario;
means for analyzing the graphical representation; and
means for generating a signature of the graphical representation responsive to analysis of the graphical representation, wherein the signature comprises a mathematical expression indicative of data of the scenario represented by the graphical representation.

29. The device of claim 28 wherein the graphical representation comprises structural information regarding a structural arrangement of the nodes of the graphical representation and the mathematical expression comprises information regarding the structural information.

30. The device of claim 28 wherein the means for analyzing comprises means for identifying a plurality of defined patterns of nodes and associations of the nodes within the graphical representation.

31. The device of claim 30 wherein the defined patterns comprise a plurality of different defined associations of nodes.

32. The device of claim 30 wherein the signature comprising the mathematical expression comprises a vector.

33. The device of claim 32 wherein values of the vector correspond to the presence of respective ones of a plurality of defined patterns of nodes and associations of the nodes in the graphical representation.

34. The device of claim 28 wherein the nodes comprise information regarding people and the associations comprise information regarding associations of the people with one another.

35. The device of claim 28 wherein the mathematical expression is indicative of the data comprising information regarding structural arrangements of the nodes of the graphical representation.

36. An article of manufacture comprising:
processor usable media comprising programming configured to cause processing circuitry to perform processing comprising:
accessing a graphical representation comprising a plurality of nodes and a plurality of associations of the nodes, wherein the nodes and the associations of the nodes are indicative of a scenario;
accessing a plurality of defined patterns comprising nodes and associations of the nodes of the defined patterns;
analyzing the nodes and associations of the nodes of the graphical representation using the defined patterns; and
providing another representation of the scenario different than the graphical representation responsive to the analyzing.

37. The article of claim 36 wherein the programming comprises programming configured to cause the processing circuitry to perform the providing comprising providing the another representation comprising a vector.

38. The article of claim 36 wherein the programming comprises programming configured to cause the processing circuitry to perform the analyzing comprising comparing individual ones of the defined patterns with respect to the graphical representation.

39. The article of claim 36 wherein the programming comprises programming configured to cause the processing circuitry to perform the analyzing comprising determining numbers of occurrences of respective ones of the defined patterns in the graphical representation.

40. The article of claim 39 wherein the programming comprises programming configured to cause the processing circuitry to perform the providing comprising providing the another representation comprising a vector using the numbers of the occurrences of the defined patterns.

41. The article of claim 36 wherein the nodes of the graphical representation comprise information regarding people and the associations of the graphical representation comprise associations of the people with one another.

42. A data signal in a transmission medium comprising:
programming configured to cause processing circuitry to access data regarding a graphical representation of a scenario;
programming configured to cause processing circuitry to access data regarding a plurality of defined patterns;
programming configured to cause processing circuitry to determine numbers of the defined patterns present in the graphical representation; and
programming configured to cause processing circuitry to provide another representation of the scenario using the numbers.

43. The signal of claim 42 wherein the data signal is embodied in a carrier wave.

44. The signal of claim 42 wherein the graphical representation comprises information regarding a plurality of nodes and associations of the nodes, and wherein the another representation of the scenario comprises information regarding the nodes and the association of the nodes of the defined patterns.

45. The signal of claim 44 wherein the defined patterns comprise different arrangements of nodes and associations of the nodes of the defined patterns.

46. The signal of claim 42 further comprising programming configured to cause processing circuitry to provide the another representation comprising a vector using the numbers.
